(19) United States
(12) Patent Application Publication
(10) Pub. No.: US 2002/0116273 A1
(43) Pub. Date: Aug. 22, 2002

(54) Method and apparatus for facilitating shipment of goods

(76) Inventor: Michael B. Sundel, Alexandria, VA (US)

Correspondence Address: NIXON PEABODY, LLP, 8180 GREENSBORO DRIVE, SUITE 800, MCLEAN, VA, 22102, US

(21) Appl. No.: 10/059,250

(22) Filed: Jan. 31, 2002

Related U.S. Application Data
(60) Provisional application No. 60/265,337, filed on Feb. 1, 2001.

(51) Int. Cl. G06F 17/60

(52) U.S. Cl. 705/19

(57) ABSTRACT

A tax and duty determination system receives shipment specific information. This shipment specific information is compared to a database containing the rules and applicable duties and/or taxes for the shipment destined for a particular destination. Based on this comparison, the tax and duty determination system determines the applicable duties and/or taxes for each item in the shipment and for the shipment as a whole.

### RELATED APPLICATION DATA

This application claims the benefit of and priority to U.S. Provisional Application Serial No. 60/265,337 filed Feb. 1, 2001, entitled “Shipping Cost Calculator System and Method,” and is related to U.S. application Ser. No. 09/996,825 entitled “Method and Apparatus for Facilitating Shipment of Packages,” filed on Nov. 30, 2001, both of which are incorporated herein by reference in their entirety.

### BACKGROUND OF THE INVENTION

1. Field of the Invention

This invention relates to systems and methods for improving the shipment of goods. In particular, this invention relates to systems and methods for facilitating a shipment of goods to an international destination.

2. Description of Related Art

Individuals and companies rely heavily on the accurate shipment of packages to both national and international destinations. Economic transactions, at one time limited to local or regional transactions, have expanded in scope to include virtually every country in the world. Many factors have lead to this, including consumer demand in one area for a product in another area, and the manufacturing of an item in a particular area to take advantage of local skills, resources, labor rates, or the like. Accordingly, the shipment of goods has become more important and frequent. The term “shipment” as used herein encompasses any flow of goods from a sender to a recipient, including returns of goods to the sender.

While some of the very largest companies may have their own vehicles for shipping goods, in general, a sender, i.e., the entity originating the shipment, that desires to ship a package to a destination will employ a designated shipping company, or shipper, to deliver the package. Such a sender must take into account many factors and keep track of numerous shipment-specific details. As an example, a sender may desire to determine the optimal shipper, based on shipping costs, speed of delivery, the shipper's expertise in handling a particular type of shipment or destination, or other particulars associated with each shipper. The sender must also keep track of a plurality of shipment-specific details. For example, the sender must track from where a particular shipment is to be dispatched; how many packages the shipment comprises; whether the entire shipment arrived at the destination; whether the shipment, or portions of the shipment, were returned to the sender; the amount of duties, taxes and other customs-related charges that will be assessed on the shipment; how and when those charges must be paid; whether those charges will be refunded if the shipment is returned; or the like.

The prior art has addressed various aspects of these concerns. For example, U.S. Pat. No. 5,968,110 discloses a method for facilitating cross-border transactions in an electronic catalog environment. All order processing and order entry procedures originate at an order processor located in the destination country, and an affiliate in the destination country handles all customs issues. U.S. Pat. Nos. 5,631,827 and 5,485,369 each disclose a system for automating transportation of goods. Rules are used to determine most appropriate shipping method.

### SUMMARY OF THE INVENTION

However, the prior art at least fails to provide a flexible solution for facilitating shipment of packages from one destination to another. For example, the prior art fails to provide a flexible means for determining duties and taxes in relation to a shipped package. Moreover, it may be desirable to obtain duty and tax information not just on a shipment basis, but on a package basis, and more particularly, on a item basis. The term “package” as used herein refers to a shipped container and its contents. The package can include, for example, a box, a crate, a carton, a plurality of the same banded together as a single entity, or the like. The term “item” as used herein refers to individual goods within a package.

One embodiment of the systems and methods of this invention provides a landed cost calculator based on a distributed network, such as the Internet, that enables a user to determine quotations of the duties and taxes that will be assessed on a shipment to a destination. By taking into consideration a number of parameters that are, for example, order-specific, client-specific and/or item-specific, the systems and methods of this invention are able accurately to determine, for example, in real-time or near real-time, the duties and taxes that will be assessed by a given country's customs authority. For example, the order-specific parameters can include an identification of the user, such as the client; the shipping method to be used, such as surface mail, air parcel post, courier expedited air, or the like; the destination country, and, in the event that the destination country contains smaller areas that have independent customs requirements, such as the Canadian provinces, an identification of the destination area; and whether the package contains a gift. The client-specific parameters can include, for example, the currency used by the user; whether the item prices are unit value prices or extended prices; and, for each possible destination country and/or destination area combination, where the shipment will clear customs. The item-specific parameters can include, for example, an identification of the user; and, for each item in the package, the description, quantity and price.

By maintaining a database that is at least able to reconcile the above parameters, the systems and methods of this invention are able accurately to determine the duties and taxes while requiring the user to provide only a small amount of data. For example, for each item that a user may be shipping internationally, the database can contain not only the duty rate by destination country, but also information relating to the applicability of each of the destination country's various taxes to that item. Furthermore, for example, to the extent that those taxes vary by the area in which customs clearance will occur, the database can contain information regarding the applicability of each area's taxes to that item.

For example, assume that a user wants to ship a package from the United States to Canada. Depending on what items the shipment contains, and where, i.e., through which province, the shipment will enter Canada, the following duties and taxes may be assessed. However, it is to be appreciated that the system and methods of this invention can be applied to any shipment destination and the appropriate duties and taxes, such as the Value Added Tax which is prevalent in Europe, determined.

Duty—For each item in the shipment, the duty rate depends on the nature of the item and its country of origin. For example, a U.S. origin item is generally assessed no duties, while clothing originating in other countries may attract a duty of approximately 20%. The duty also depends on the total value of the shipment, as shipments valued at less than 20 Canadian dollars are generally exempt from taxes and duties. The duty further depends on whether the shipment is a gift from a non-resident of Canada, as the first 60 Canadian dollars of a gift are generally exempt from duties and taxes.

Excise Tax—A federal luxury tax assessed at the rate of 10% of the duty-inclusive value for jewelry, and 10% of the duty-inclusive value over 50 Canadian dollars for watches and clocks. The excise tax also depends on the total value of the shipment, as shipments valued at less than 20 Canadian dollars are generally exempt from duties and taxes. The excise tax also depends on whether the shipment is a gift from a non-resident of Canada, as the first 60 Canadian dollars of a gift are generally exempt from duties and taxes.

Goods and Services Tax—The goods and services tax is a federal consumption tax generally assessed at the rate of 7% of the duty-and-excise-tax inclusive value for all items. The goods and services tax also depends on the total value of the shipment, as shipments valued at less than 20 Canadian dollars are generally exempt from duties and taxes. The goods and services tax also depends on whether the shipment is a gift from a non-resident of Canada, as the first 60 Canadian dollars of a gift are generally exempt from duties and taxes.

Provincial Sales Tax—The provincial sales tax is a local tax that is similar to the U.S. state sales tax, with the rate and applicability rules varying by location. In general, the provincial sales taxes are between 7% and 8%of the duty-and-excise-tax-inclusive value, and are assessed only when the entry point is in the destination province. For example, shipments destined to Ontario that enter Canada through British Columbia are assessed neither Ontario nor British Columbia provincial sales tax. The provincial sales tax also depends on the total value of the shipment, as shipments valued at less than 20 Canadian dollars are generally exempt from duties and taxes. The provincial sales tax also depends on whether the shipment is a gift from a non-resident of Canada, as the first 60 Canadian dollars of a gift are generally exempt from duties and taxes.

Harmonized Sales Tax—The harmonized sales tax is a combination of the goods and services tax and the provincial sales tax that is assessed at the rate of 15% of the duty-and-excise-tax-inclusive value when the destination province is either New Brunswick, Nova Scotia, or Newfoundland. The harmonized sales tax is collected by the federal government regardless of where the shipment enters Canada. For example, shipments destined to Nova Scotia that enter Canada through British Columbia are assessed the harmonized sales tax. The harmonized sales tax is collected while the goods and services tax is not. However, harmonized sales tax exempt items, such as books, in shipments destined to New Brunswick, Nova Scotia, and Newfoundland, are still assessed the goods and services tax. The harmonized sales tax also depends on the total value of the shipment, as shipments valued at less than 20 Canadian dollars are generally exempt from duties and taxes. The harmonized sales tax also depends on whether the shipment is a gift from a non-resident of Canada, as the first 60 Canadian dollars of a gift are generally exempt from duties and taxes.

As complicated a scheme as this may appear to be, the systems and methods of this invention take into account all the potential duties and taxes, as well as the potential exemptions, when determining duties and taxes for a particular shipment.

Aspects of the present invention relate to the shipment of goods. In particular, the systems and methods of this invention facilitate the shipment of goods by determining duties and taxes.

Aspects of the present invention also relate to systems and methods that are capable of determining duties and taxes that may be assessed on particular items within a shipment.

Aspects of the present invention additionally relate to systems and methods that allow for one or more users to determine at least one of duties and taxes assessed on a shipment via a user interface that can be accessed over, for example, a distributed network.

Additionally, the systems and methods of this invention can be used in conjunction with co-pending U.S. Ser. No. 09/996,825 entitled “Method and Apparatus for Facilitating Shipment of Packages,” filed on Nov. 30, 2001, and incorporated herein by reference in its entirety.

These and other features and advantages of this invention are described in or are apparent from the following detailed description of the embodiments.

### BRIEF DESCRIPTION OF THE DRAWINGS

The embodiments of the invention will be described in detail, with reference to the following figures wherein:

FIG. 1 is a functional block diagram illustrating an exemplary duty and tax determination system according to an embodiment of this invention;

FIG. 2 is a screen shot illustrating an exemplary user interface according to an embodiment of this invention;

FIG. 3 is a screen shot illustrating an exemplary user interface according to an embodiment of this invention;

FIG. 4 is a screen shot illustrating an exemplary user interface according to an embodiment of this invention;

FIG. 5 is a screen shot illustrating an exemplary user interface according to an embodiment of this invention;

FIG. 6 is a screen shot illustrating an exemplary user interface according to an embodiment of this invention;

FIG. 7 is a screen shot illustrating an exemplary user interface according to an embodiment of this invention;

FIG. 8 is a screen shot illustrating an exemplary user interface according to an embodiment of this invention; and

FIG. 9 is a flow chart outlining an exemplary method for determining duties and taxes according to an embodiment of this invention.

### DETAILED DESCRIPTION OF THE INVENTION

An exemplary embodiment of the systems and methods according to this invention allows a user to input one or more criteria relating to items in a shipment. For example, a user can enter the type of item(s) contained in a shipment, the quantity of each item(s), the value of each item(s) and whether the item(s) is a gift. Based on these criteria, and, for example, the origin and destination addresses of the shipment, the systems and methods of this invention are able to determine the duties and taxes that may be assessed, if any. Furthermore, an exemplary embodiment of the systems and methods of this invention allows a user to alter criteria, such as shipment methods, so that the user is able to see variations in the duties and taxes.

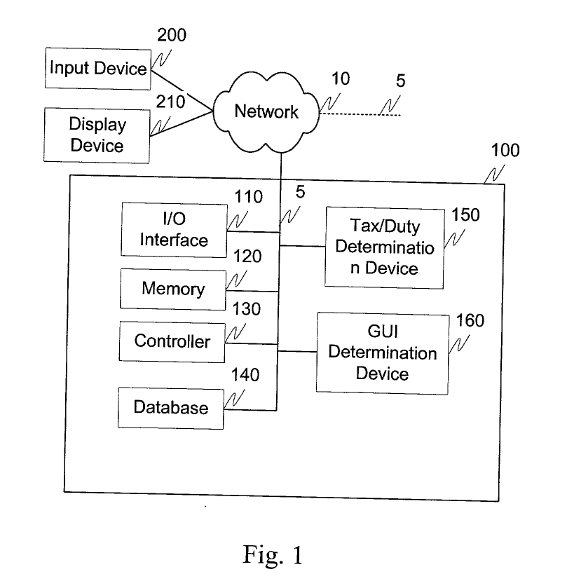

FIG. 1 illustrates an exemplary tax and duty determination system 100. The tax and duty determination system 100 comprises an I/O interface 110, a memory 120, a controller 130, a database 140, a tax/duty determination device 150 and a graphical user interface (GUI) determination device 160, all interconnected by link 5. The tax and duty determination system 100 is connected to one or more networks 10, such as a distributed network, as well as an input device 200 and a display device 210.

While the exemplary embodiment illustrated in FIG. 1 shows the tax and determination system 100 and associated components collocated, it is to be appreciated that the various components of the tax and duty determination system 100 can be located at distant portions of a distributed network, such as a local area network, a wide area network, an intranet and/or the internet, or with any dedicated tax and duty determination system. Thus, it should be appreciated that the components of the tax and duty determination system 100 can be combined into one device or collocated on a particular node of a distributed network. As will be appreciated from the following description, and for reasons of computational efficiency, the components of the tax and duty determination system can be arranged at any location within a distributed network without affecting the operation of the system.

Furthermore, the link 5 can be a wired or a wireless link or any other known or later developed element(s) that is capable of supplying and communicating electronic data to and from the connected elements. Additionally, the input device 200 can be, for example, a keyboard, a mouse, a speech-to-text converter, an input from a dedicated package processing system, or the like. The display device 220 can be, for example, a computer monitor, a display on a PDA, or any other device capable of displaying information to one or more users.

In operation, a user, via input device 200, enters one or more of, for example, the shipment method, the destination location, whether or not items within the shipment are a gift, and information specific to items within the shipment. For example, the specific information can include, but is not limited to, the identification of the item, the unit price, and the quantity of items within the shipment. This input information is received, via network 10 and link 5, and with the cooperation of the I/O interface 110, stored in the memory 120. The controller 130, in cooperation with the database 140, analyzes the input information and determines whether supplemental destination information is needed. For example, if a location, such as a state, within a destination location has separate taxes and/or duties, a graphical user interface displayed on display device 220, will be updated, with the cooperation of graphic user interface determination device 160. If it is determined that supplemental destination information is needed, the graphical user interface on display device 220 is updated so that the user, via input device 200, can enter the supplemental destination information. Additionally, the tax and duty determination system 100 prompts the user to enter, via display device 200, whether this shipment, or any items within the shipment, are gifts. A user can then select, for example, via the input device 200, a check box, indicating that one or more items in the shipment are gifts. Upon receipt of all the necessary information regarding the shipment, the tax and duty determination system 100 determines any applicable duties and/or taxes for the shipment. In particular, the tax and duty determination system 100, in cooperation with the database 140 and the tax/duty determination device 150, analyzes the input data and compares it to information within the database 140. The database 140 stores, for example, not only the duty rate by destination country, but also information pertaining to the applicability of each of the destination country's various taxes and duties to that item. Furthermore, to the extent that those taxes vary by the area in which customs clearance will occur, the database 140 contains information regarding applicability of each area's taxes to that item. Additionally, the database can be configured to maintain a record for each item, such as a SKU, that a client ships. Therefore, for example, a higher accuracy can be achieved than the accuracy generally associated with a keyword based database. Thus, upon determination of any applicable duties and/or taxes on the shipment, the controller 130, in cooperation with the duty determination device 160 and the tax/duty determination device 150, updates the display device 220, via the link 5 and the network 10, to display the total amount of duties and taxes, if any, based on the received information. Alternatively, the tax and duty determination system can output any tax and duty information to an associated shipping type system via, for example, link 5 and network 10.

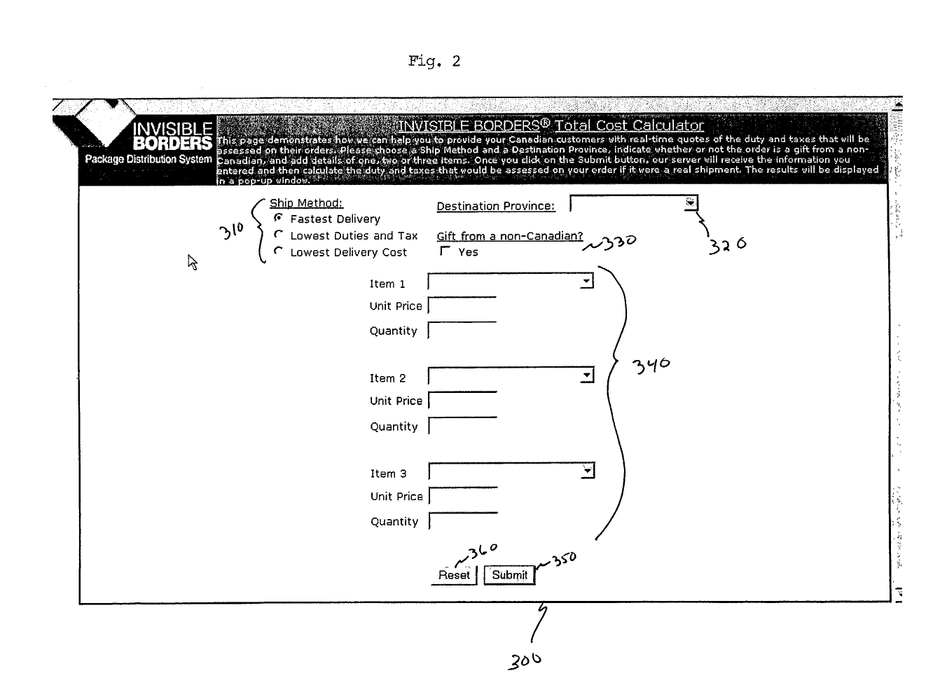

FIG. 2 illustrates an exemplary user interface that may be displayed, for example, on display device 220. The exemplary user interface comprises a shipment method selection portion 310, a destination portion 320, an indication that one or more items within the shipment are a gift 330, an item portion 340, a submit portion 350 and a reset portion 360. It should be appreciated that the exemplary user interface 300 can be modified, for example, to further specify that particular items within the shipment are gifts, and also to supply supplemental selection portions for areas within a selected destination. Furthermore, it should be appreciated that, while the exemplary user interface 300 is shown using radio buttons and pull down menus, any known or later developed graphical user interface components can be used equally well with the systems and methods of this invention.

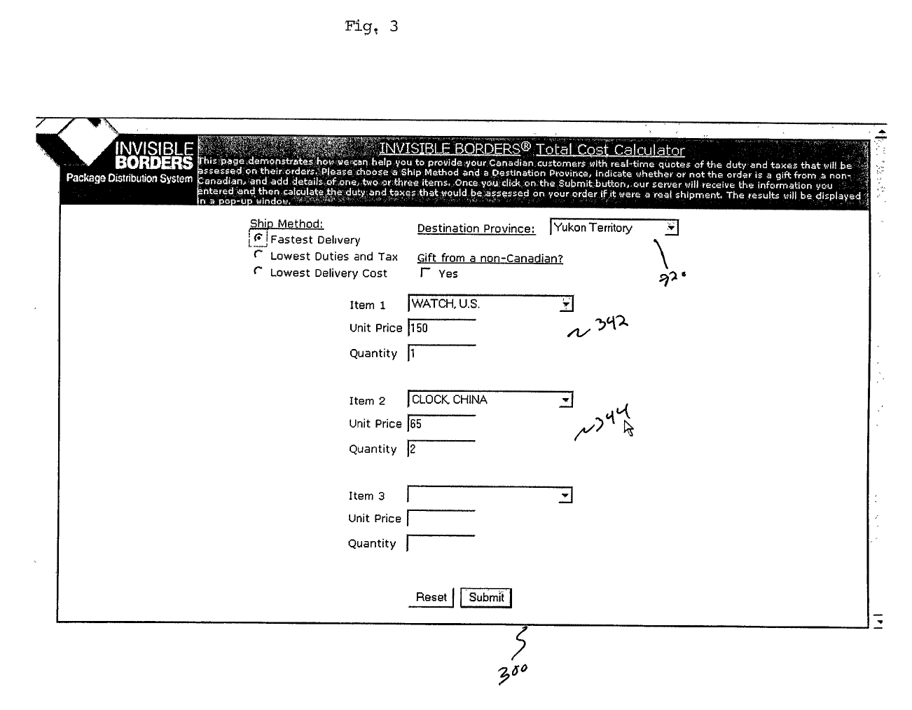

Thus, as illustrated in FIG. 3, a user enters shipment information, destination information, and item information. In this particular instance, item 342 is specified as being a watch made in the U.S., with a unit price of $150, and the shipment contains one of them. Furthermore, item 344 is specified as being a clock made in China with a unit price of $65.00, and there are two of the clocks within the shipment. For this exemplary shipment, the destination is the Yukon Territory, and the user has selected the fastest delivery method.

Additionally, the user interface 300 comprises a submit button 350 and a reset button 360. Upon selection of the submit button 350, the shipment information is forwarded to the tax and duty determination system 100. Alternatively, if a user selects the reset button 360, all or a portion of the user interface is reset to a default state.

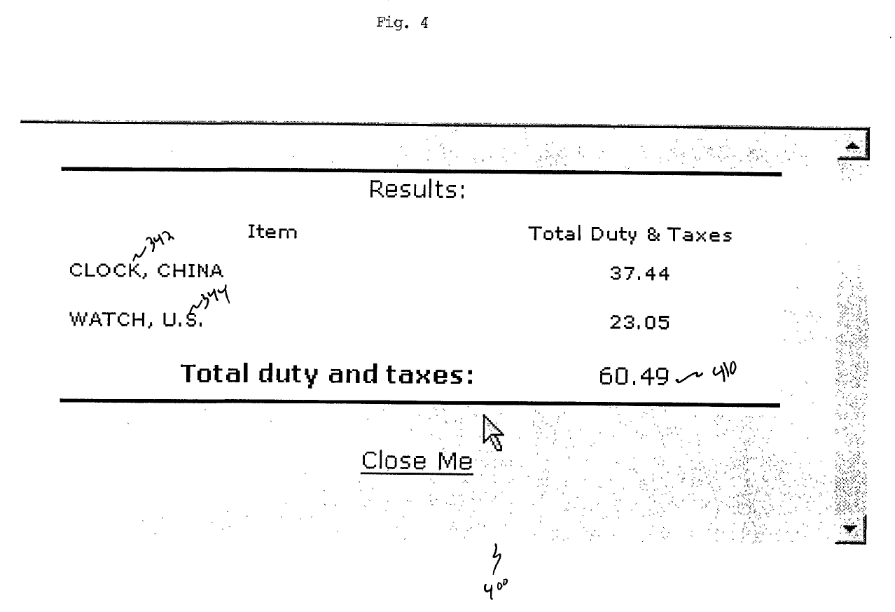

FIG. 4 illustrates an exemplary user interface that can be displayed on, for example, display device 230 showing the duties and taxes for the items 342 and 344 with a total of the duties and taxes being $60.49 for the entire shipment.

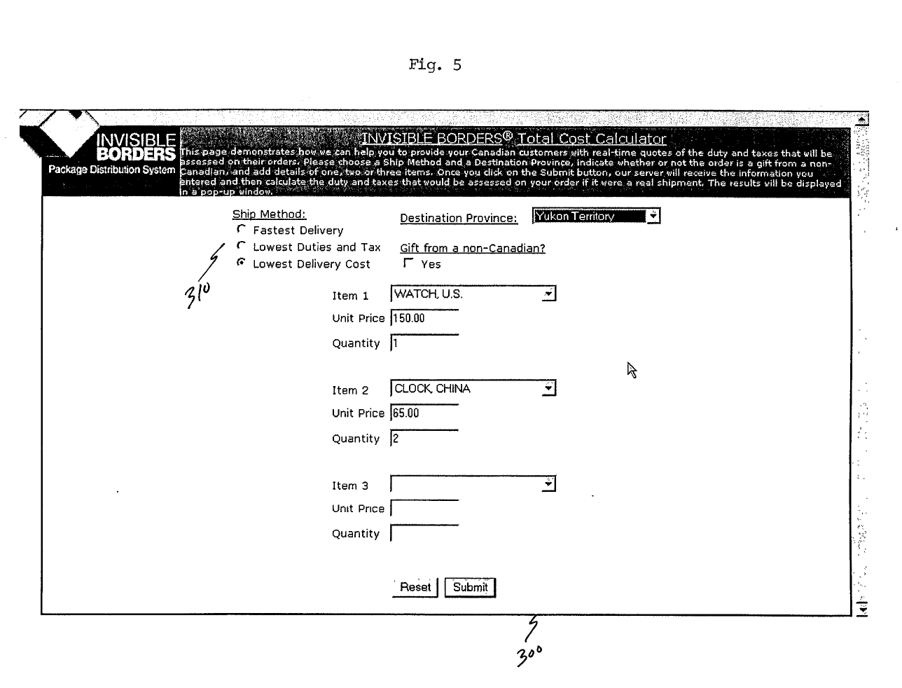

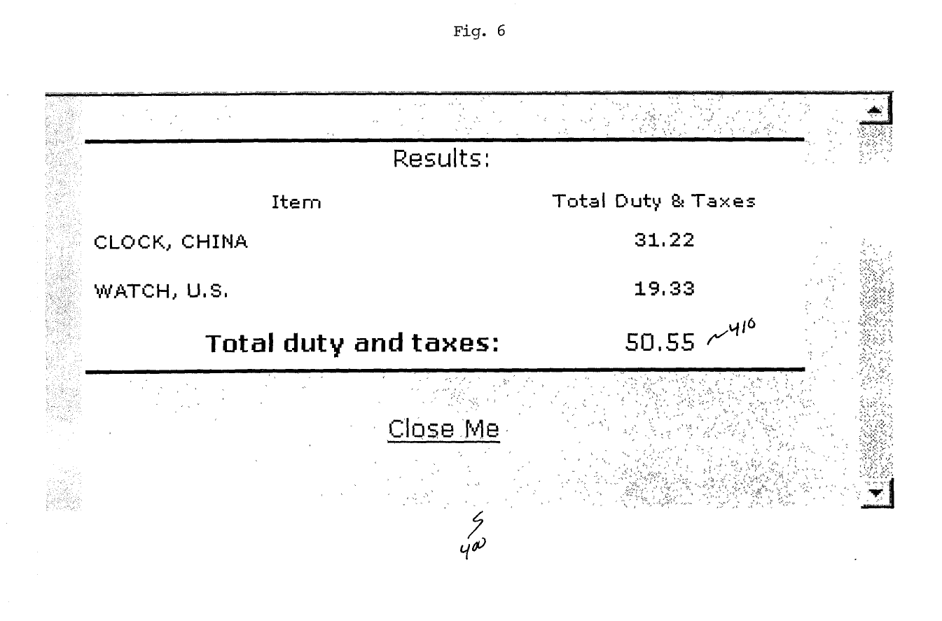

FIG. 5 illustrates an exemplary user interface 300 in which the user has indicated there should be one watch and two clocks. However, the user has specified in the shipment portion 310, the lowest delivery cost option. Thus, as illustrated in FIG. 6, the total duty and tax user interface 400 shows the total duty and taxes for the shipment 410 to be $50.55.

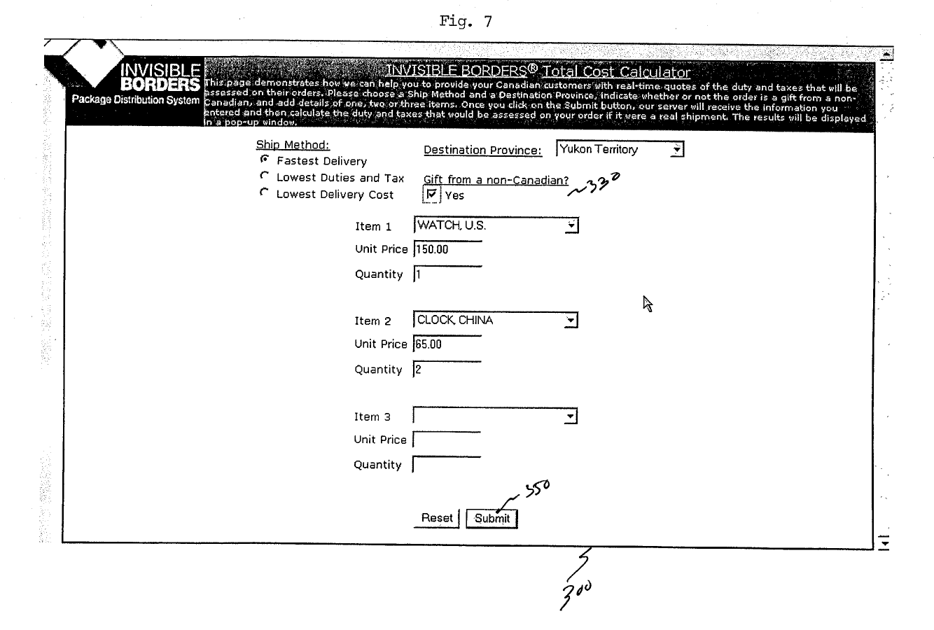

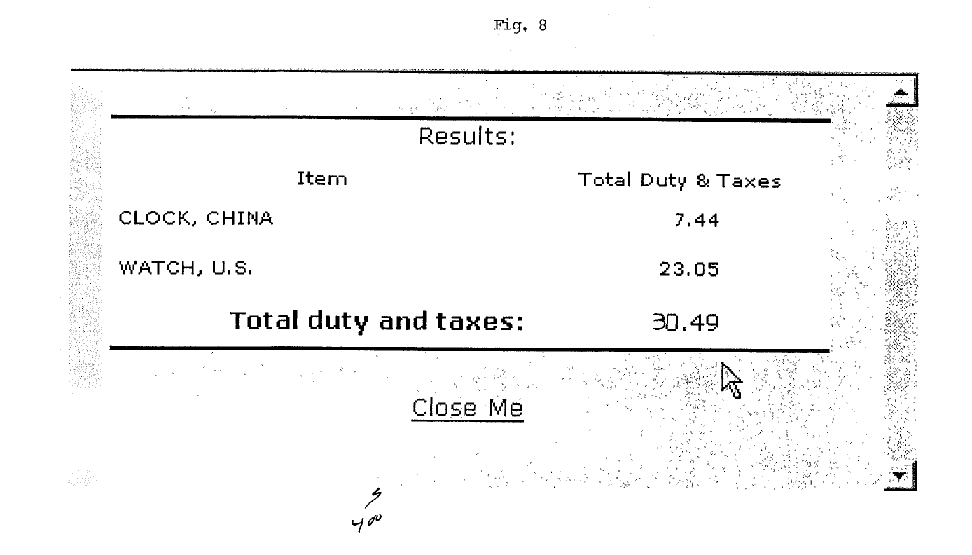

FIG. 7 illustrates an exemplary user interface 300 in which a user has indicated that the items within the shipment are gifts. Thus, upon selection of the submit button 350, the tax an duty determination system 100 displays, as illustrated in FIG. 8, the on display device 230, the user interface 400 showing the total duty and taxes taking into consideration that the items are gifts.

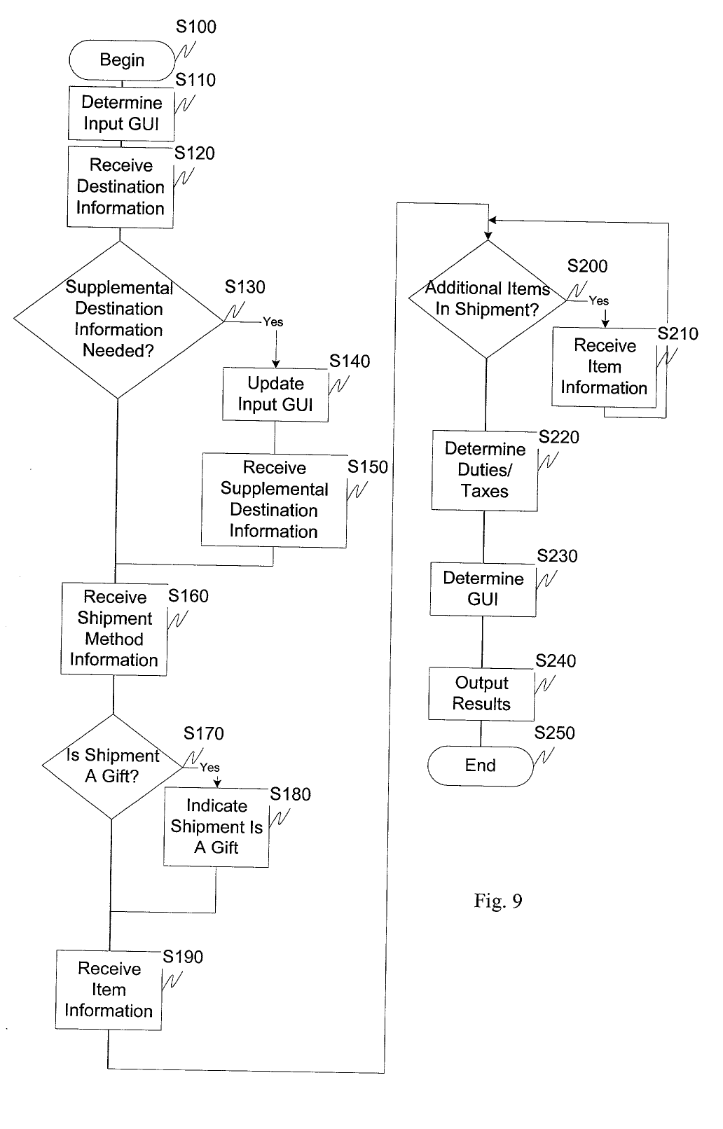

FIG. 9 is a flowchart illustrating an exemplary method of determining taxes and duties according to an embodiment of the present invention. In particular, control begins in step S100 and continues to step S110. In step S110, the input graphical user interface is determined. Next, in step S120, destination information is received. Then, in step S130, a determination is made whether supplemental destination information is needed based on the received destination information.

If supplemental destination information is needed, control continues to step S140. Otherwise control jumps to step S160.

In step S140, the input graphical user interface is updated. Next, in step S150, supplemental destination is received and control continues to step S160.

In step S160, shipment method information is received. Next, in step S170, a determination is made whether one or more items within the shipment are gifts. If one or more items in the shipment are gifts, control continues to step S180 where the items which are gifts are identified thereas. Control then continues to step S190. In step S190, item specific information is received. Control then continues to step S200.

In step S200, a determination is made whether additional items are present in the shipment. If additional items are present in the shipment, control continues to step S210. Otherwise, control jumps to step S220.

In step S210, the information relating to the additional items is received and control continues back to step S200.

In step S220, the duties and taxes, if any, are determined. Furthermore, for example, shipment-level exemptions, assessment thresholds, and the like, can be accounted for. For example, in the case of a gift going to Canada that is valued at more than 60 Canadian dollars, each item's value can be reduced on a pro rata basis to take into account the gift exemption before determining the duties and taxes. Next, in step S230, a graphical user interface for displaying the duties and taxes for the applicable shipment is determined. Then, in step S240, the results of the duty/tax determination are displayed, for example, on a display device. For example, the results can be displayed in either one of or both of an item-specific or shipment level configuration. Thus, for example, a client could delete an item from the shipment that may incur especially high duties and taxes without the need to cancel the entire order. Control then continues to step S250 where the control sequence ends.

As shown in FIG. 1, the tax and duty determination system can be implemented either on a single program general purpose computer or a separate program general purpose computer. However, the tax and duty determination system can also be implemented on a special purpose computer, a programmed microprocessor or microcontroller and peripheral integrated circuit element, an ASIC or other integrated circuit, a digital signal processor, a hardwired electronic or logic circuit such as a discrete element circuit, a programmable logic device such a PLD, PLA, FPGA, PAL, or the like. In general, any device capable of implementing a finite state machine that is in turn capable of implementing the steps in the flowchart illustrated in FIG. 9 can be used to implement the tax and duty determination system according to this invention.

Furthermore, the disclosed method may be readily implemented in software using object or object-oriented software development environments that provide portable source code that can be used on a variety of computer or workstation hardware platforms. Alternatively, the disclosed tax and duty determination system can be implemented partially or fully in hardware using standard logic circuits or VLSI design. Whether software or hardware is used to implement the systems in accordance with this invention is dependent on the speed and/or efficiently requirements of the systems, the particular function, and the particular software and/or hardware systems or microprocessor or microcomputer being utilized. However, the tax and duty determination systems and methods illustrated herein can be readily implemented in hardware and/or software using any known or later-developed systems or structures, devices and/or software by those of ordinary skill in the applicable art from the functional description provided herein and with a general basic knowledge of the computer arts.

Moreover, the disclosed methods may be readily implemented as software executed on a programmed general purpose computer, a special purpose computer, a microprocessor, or the like. In these instances, the methods and systems of this invention can be implemented as a program embedded on a personal computer, such as a JAVA® or CGI script, as a resource residing on a server or graphics workstation, as a routine embedded on a dedicated tax and duty determination system, a web browser, a PDA, a dedicated tax and duty determination system, a shipment tracking system, or the like. The tax and duty determination system can also be implemented by physically incorporating the system into a software and/or hardware system, such as the hardware and software systems of a computer workstation or dedicated tax and duty determination system.

It is, therefore, apparent that there has been provided, in accordance with the present invention, systems and methods for determining taxes and duties for a shipment. While this invention has been described in conjunction with a number of embodiments, it is evident that many alternatives, modifications and variations would be or are apparent to those of ordinary skill in the applicable arts. Accordingly, the invention is intended to embrace all such alternatives, modifications, equivalents and variations that are within the spirit and scope of this invention.

What is claimed is:

1. A cost determination system for one or more shipments comprising:
a database comprising at least one of tax and duty information;
a cost determination device that communicates with the database to determine at least one of tax and duty information for at least one of the one or more shipments; and
a graphical user interface determination device that is capable of determining a presentation format based on the at least one of tax and duty information and the one or more shipments.

2. The system of claim 1, further comprising an input device wherein a user inputs information relating to the one or more shipments.

3. The system of claim 1, wherein the one or more shipments comprise one or more packages.

4. The system of claim 3, wherein the one or more packages each comprise one or more items.

5. The system of claim 1, wherein the cost determination device is capable of determining at least one of tax and duty information for one or more of the one or more shipments, one or more packages and one or more items.

6. The system of claim 1, wherein the at least one of tax and duty information comprises at least one of excise tax information, goods and services tax information, provincial sales tax information, harmonized sales tax information, other tax information, and import duty information.

7. The system of claim 1, wherein the cost determination device is capable of determining exemptions to the at least one of tax and duty information.

8. The system of claim 2, wherein the user input information comprises a shipment method, a destination location, an origination location, gift information, item identification information, price information and quantity information.

9. The system of claim 1, wherein the cost determination device is capable of querying a user to enter supplemental destination information to assist in determining the at least one of tax and duty information for the at least one of the one or more shipments.

10. The system of claim 1, further comprising a communications device that allows for the determined at least one of tax and duty information to be output.

11. A cost determination method that determines a cost associated with one or more shipments comprising:
receiving information associated with the one or more shipments;
accessing a database comprising at least one of tax and duty information;
determining at least one of tax and duty information for at least one of the one or more shipments; and
assembling and outputting cost information based on the at least one of tax and duty information and the information associated with the one or more shipments.

12. The method of claim 11, further comprising receiving information relating to the one or more shipments via a graphical user interface.

13. The method of claim 11, wherein the one or more shipments comprise one or more packages.

14. The method of claim 13, wherein the one or more packages each comprise one or more items.

15. The method of claim 11, further comprising determining at least one of tax and duty information for one or more of the one or more shipments, one or more packages and one or more items.

16. The method of claim 11, wherein the at least one of tax and duty information comprises at least one of excise tax information, goods and services tax information, provincial sales tax information, harmonized sales tax information, other tax information, and import duty information.

17. The method of claim 11, further comprising determining exemptions to the at least one of tax and duty information.

18. The method of claim 12, wherein the user input information comprises a shipment method, a destination location, an origination location, gift information, item identification information, price information and quantity information.

19. The method of claim 11, further comprising querying a user to enter supplemental destination information to assist in determining the at least one of tax and duty information for the at least one of the one or more shipments.

20. The method of claim 11, further comprising allowing for the determined at least one of tax and duty information to be shared with one or more other systems.
